(19) United States
(12) Patent Application Publication
(10) Pub. No.: US 2015/0111585 A1
(43) Pub. Date: Apr. 23, 2015

(54) RADIO COMMUNICATION SYSTEM, RADIO COMMUNICATION APPARATUS, AND RADIO COMMUNICATION METHOD

(71) Applicant: Yoshinori Utsumi, Tokyo (JP)

(72) Inventor: Yoshinori Utsumi, Tokyo (JP)

(73) Assignee: Mitsubishi Electric Corporation, Tokyo (JP)

(21) Appl. No.: 14/385,893

(22) PCT Filed: Mar. 19, 2013
(86) PCT No.: PCT/JP2013/057906

§ 371 Date: Sep. 17, 2014

(30) Foreign Application Priority Data
Apr. 18, 2012 (JP) 2012-094863

(51) Int. Cl. H04W 24/04; H04W 16/24

(52) U.S. Cl. CPC H04W 24/04; H04W 16/24
USPC 455/448

(57) ABSTRACT

In a radio communication system that allows coexistence of a plurality of radio network systems, a radio node 1 that belongs to a first radio network system and temporarily belongs to a second radio network system includes a system-coordination control unit 13 that gives a notification indicating that the radio node 1 temporarily becomes unavailable when the radio node 1 starts operating as a radio node that belongs to the second radio network system, wherein when a radio node that belongs to the first radio network system and is adjacent to the radio node 1 receives a notification of temporary node unavailability, the radio node changes a radio communication parameter between this radio node and the radio node 1 to a value such that the radio node 1 is not detected as faulty.

### FIELD

The present invention relates to a radio communication system, a radio communication apparatus, and a radio communication method.

### BACKGROUND

In a case where a radio node is shared among a plurality of radio network systems (for example, a radio network system #1 and a radio network system #2), the radio node cannot operate as a node for the radio network system #2, while operating as a node for the radio network system #1. In such a case, it appears that a fault has occurred in the radio node in the network in the radio network system #2. As a result, at the side of the radio network system #2, network processing such as routing-table changing processing for bypassing the radio node is performed.

In order for the radio node that is shared among the radio network systems not to be recognized as a faulty node, it suffices that the radio network systems can coexist in the same space (the radio network systems can communicate within their own networks, respectively, in the same space). A method for the radio network systems to coexist in the same space has been considered, in which the radio network systems are time-synchronized with each other, thereby separating the time slots, during which the radio network systems operate, from each other, or in which the radio network systems respectively use separate radio channels, thereby separating the frequencies, at which the radio network systems operate, from each other.

For example, Patent Literature 1 proposes a technique in which a period of a network frame that can be repeatedly utilized by a plurality of radio networks is set with a predetermined time period, and a plurality of channel slots that can be utilized respectively by the radio networks are allocated within the network frame in order to constitute the radio networks that are independent from each other. Patent Literature 2 proposes a technique in which the base station transmits notification information by using allocated frequency channels that differ according to the radio zones to perform access control among a plurality of radio network groups.

### CITATION LIST

### Patent Literatures

Patent Literature 1: Japanese Patent Application Laid-open No. 2003-309572

Patent Literature 2: Japanese Patent Application Laid-open No. 2004-112556

### SUMMARY

### Technical Problem

However, in the method described in Patent Literature 1 mentioned above, because the channel slots are allocated respectively to the radio networks, a plurality of radio network systems need to be time-synchronized with each other. Therefore, there is a problem that the size of the system size is increased and the system becomes costly because a GPS (Global Positioning System) is utilized to establish timing synchronization among all the nodes that constitute the radio network systems, for example.

In the method of using different frequencies as described in Patent Literature 2 mentioned above, a radio node that is shared among a plurality of radio network systems needs to include as many transceivers as the number of the systems that share the radio node. Therefore, this method has a problem that it is costly.

The present invention has been achieved to solve the above problems, and an object of the present invention is to provide a radio communication system, a radio communication apparatus, and a radio communication method that can suppress occurrence of unnecessary traffic caused by regarding a radio node that is shared among a plurality of radio network systems as a faulty node when the radio network system to which the radio node belongs is changed.

### Solution to Problem

In order to solve the above problems and achieve the object, the present invention is a radio communication system that allows coexistence of a plurality of radio network systems in a same space, the system including: a shared node that belongs to a first radio network system that is one of the radio networks and that temporarily belongs to a second radio network system that is one of the radio networks and is different from the first radio network system; and an adjacent node that belongs to the first radio network system and is adjacent to the shared node, wherein the shared node includes a system-coordination control unit that, when the shared node starts operating as a radio node that belongs to the second radio network system, gives a notification of temporary node unavailability indicating that the shared node temporarily becomes unavailable, and the adjacent node includes a communication processing unit that, upon reception of a notification of the temporary node unavailability, changes a radio communication parameter between the adjacent node and the shared node to a value such that the shared node is not detected as faulty even when there is no response from the shared node for a certain period of time.

### Advantageous Effects of Invention

The radio communication system according to the present invention obtains an effect where it is possible to suppress occurrence of unnecessary traffic caused by regarding a radio node that is shared among a plurality of radio network systems as a faulty node when the radio network system to which the radio node belongs is changed.

### BRIEF DESCRIPTION OF DRAWINGS

FIG. 1 is a diagram of a configuration example of a radio communication system according to a first embodiment.

FIG. 2 is a block diagram of a configuration example of a shared node.

FIG. 3 is a block diagram of a configuration example of radio nodes that belong to a first system.

FIG. 4 is a block diagram of a configuration example of a radio node that belongs to a second system.

FIG. 5 is a flowchart of an example of a message reception process procedure in a system-coordination control unit.

FIG. 6 is a chart of an example of a notification process procedure to adjacent nodes.

FIG. 7 is a chart of an example of an operation sequence of a radio network system according to a second embodiment.

FIG. 8 is a diagram of a configuration example of a shared node that constitutes a radio network system according to a third embodiment.

FIG. 9 is a block diagram of a configuration example of a radio node that belongs to a second system according to the third embodiment.

FIG. 10 is a sequence diagram of an operation example according to a fourth embodiment.

FIG. 11 is a diagram of a configuration example of radio nodes that are adjacent to a shared node and belong to a first system according to the fourth embodiment.

FIG. 12 is a flowchart of an operation example when the radio nodes of the fourth embodiment receive temporary node unavailability.

FIG. 13 is a diagram of a configuration example of radio nodes that are adjacent to a shared node and belong to a first system according to a fifth embodiment.

### DESCRIPTION OF EMBODIMENTS

Exemplary embodiments of a radio communication system, a radio communication apparatus, and a radio communication method according to the present invention will be explained below in detail with reference to the drawings. The present invention is not limited to the embodiments.

### First Embodiment

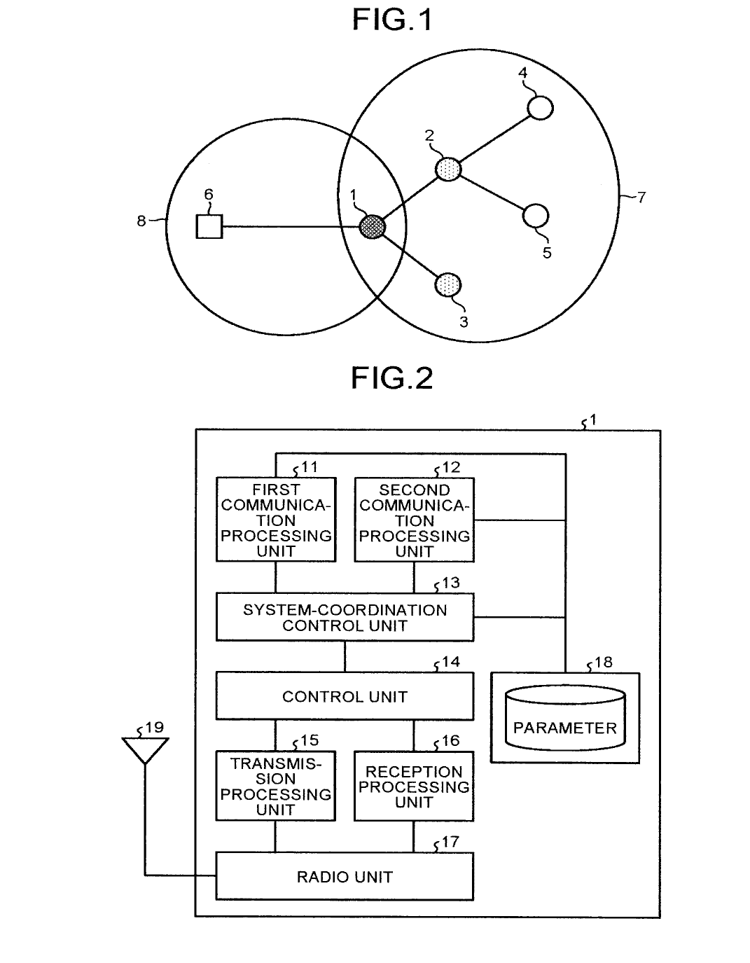

FIG. 1 is a diagram of a configuration example of a radio communication system according to a first embodiment of the present invention. As shown in FIG. 1, a radio network system according to the present embodiment includes radio nodes (radio communication apparatuses) 1 to 6. The radio node 1 (a shared node) is a radio node that belongs to both a first radio network system 7 and a second radio network system 8. The radio nodes 2, 3, 4, and 5 belong to the first radio network system 7. The radio nodes 2 and 3 are nodes adjacent to the radio node 1 within the first radio network system 7. The radio nodes 1 to 5 are each connected to its adjacent radio nodes by radio lines and constitute the first radio network system 7. The radio node 6 is a radio node that belongs to the second radio network system 8, is connected to the radio node 1 by a radio line, and constitutes the second radio network system 8.

FIG. 2 is a block diagram of a configuration example of the radio node 1. As shown in FIG. 2, the radio node 1 includes a first communication processing unit 11 that performs communication processing in the first radio network system 7 (hereinafter, “first system”), a second communication processing unit 12 that performs communication processing in the second radio network system 8 (hereinafter, “second system”), and a system-coordination control unit 13 that controls a coordinated operation between the first communication processing unit 11 and the second communication processing unit 12. The radio node 1 further includes a control unit 14 that controls its own entire node, a transmission processing unit 15 that performs message transmission processing, a reception processing unit 16 that performs message reception processing, a radio unit 17 that transmits a message from the transmission processing unit 15 as a radio signal via an antenna 19 and passes the radio signal received through the antenna 19 to the reception processing unit 16, a database (a parameter storage unit) 18 that stores therein parameters necessary for an operation of its own node, and the antenna 19.

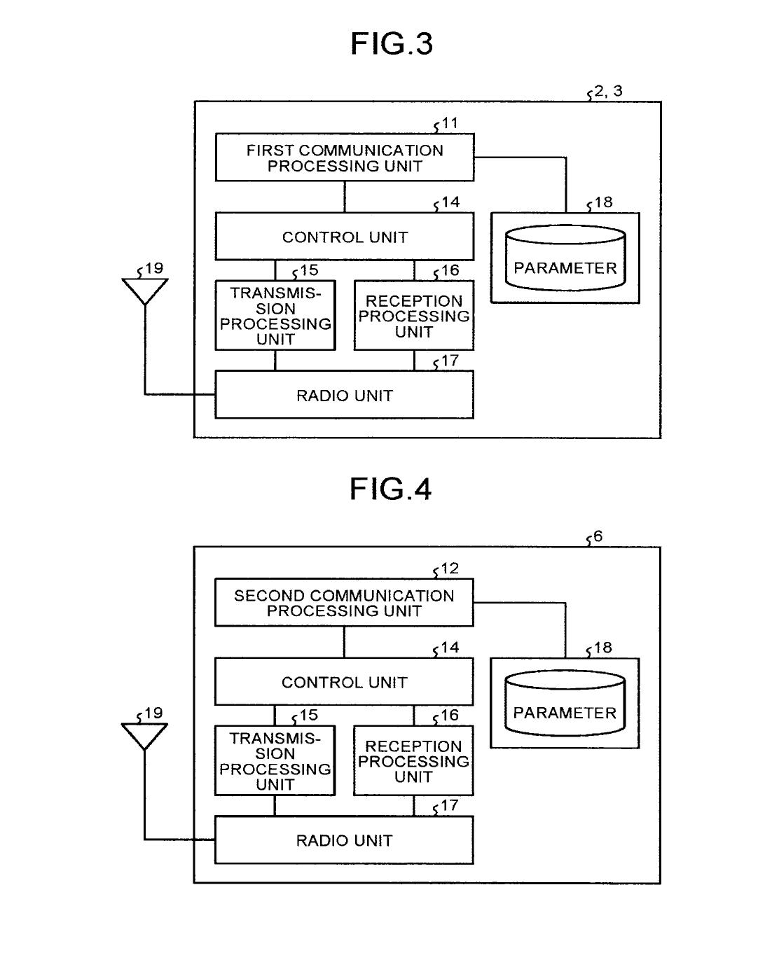

FIG. 3 is a block diagram of a configuration example of radio nodes (the radio nodes 2 to 5) that belong to the first system. As shown in FIG. 3, each of the radio nodes that belong to the first system includes the first communication processing unit 11, the control unit 14 that controls its own entire node, the transmission processing unit 15 that performs message transmission processing, the reception processing unit 16 that performs message reception processing, the radio unit 17 that transmits a message from the transmission processing unit 15 as a radio signal via the antenna 19 and passes the radio signal received through the antenna 19 to the reception processing unit 16, the parameter storage unit 18 that stores therein parameters necessary for an operation of its own node, and the antenna 19.

FIG. 4 is a block diagram of a configuration example of a radio node (the radio node 6) that belongs to the second system. As shown in FIG. 4, the radio node that belongs to the second system has the same configuration as the radio nodes that belong to the first system except that the radio node of the second system includes the second communication processing unit 12, which performs communication processing in the second system, instead of the first communication processing unit 11.

An operation is explained next. Here, an explanation is made of the environment in which normally, the first system that provides a main service operates, but the second system operates when the radio node 6 is temporarily connected to the radio node 1. When the radio network system operates as the first system, the radio node 1 and the radio nodes 2 to 5 construct and maintain the first system through an operation of the first communication processing unit 11.

For example, when the radio node 1 is connected to the radio node 2, a connection request message is generated in the first communication processing unit 11 in the radio node 1, and the message is transmitted from the antenna 19 to the radio node 2 by using the transmission processing unit 15 and the radio unit 17 under the control of the control unit 14 in the radio node 1. At this point, the system-coordination control unit 13 in the radio node 1 stores therein the start of an operation of the radio node 1 as a node for the first system. In the radio node 2, the control unit 14 receives the connection request message through the antenna 19, the radio unit 17, and the reception processing unit 16, and passes the message to the first communication processing unit 11 to execute a connection control sequence between the radio node 1 and the radio node 2. The parameter for this communication control sequence is held in the database 18 in each of the radio nodes 1 and 2.

The radio node 6 that belongs to the second system then transmits a connection request to the radio node 1. That is, a connection request message is generated in the second communication processing unit 12 in the radio node 6, and is transmitted from the antenna 19 to the radio node 1 by using the transmission processing unit 15 and the radio unit 17 under the control of the control unit 14.

In the radio node 1, the control unit 14 receives the connection request message from the radio node 6 through the antenna 19, the radio unit 17, and the reception processing unit 16, and passes the message to the second communication processing unit 12 through the system-coordination control unit 13 to start a connection control sequence between the radio node 1 and the radio node 6. A connection request message includes information for distinguishing radio network systems from each other (information to distinguish the first system from the second system). Based on this information, the system-coordination control unit 13 determines whether a received message has come from the first system or from the second system, and selects a message output destination (the first communication processing unit 11 or the second communication processing unit 12) based on the determination result.

At this point, the system-coordination control unit 13 in the radio node 1 detects that the radio node that has been operating as a node for the first system starts operating as a new node for the second system.

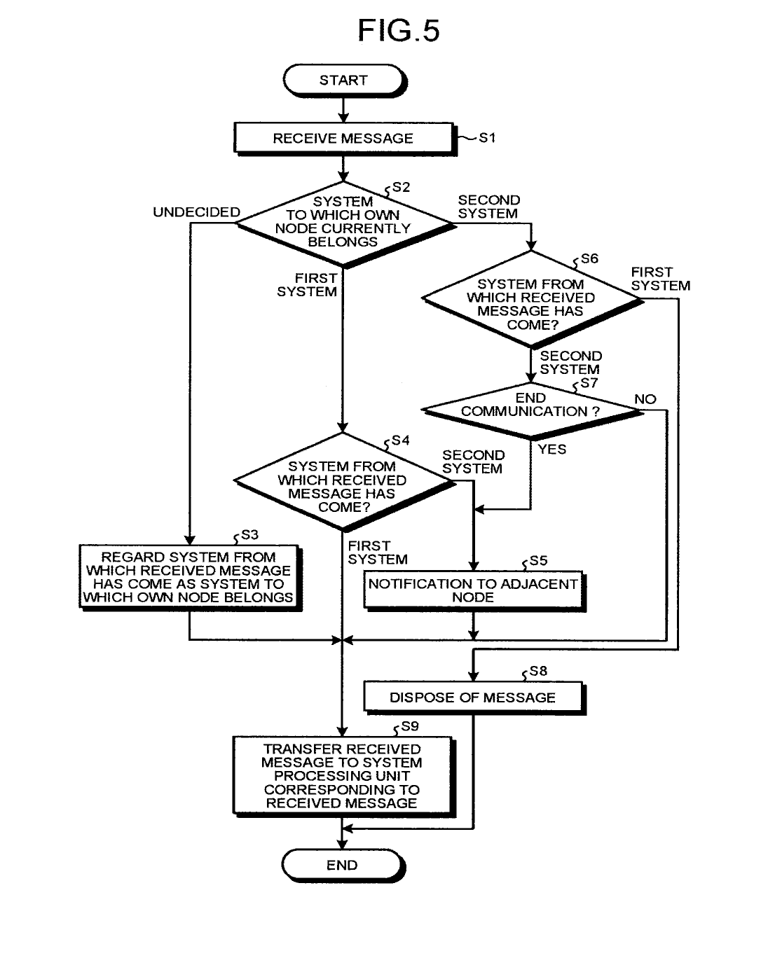

An operation of the system-coordination control unit 13 is explained with reference to FIG. 5. FIG. 5 is a flowchart of an example of a message reception process procedure in the system-coordination control unit 13. First, when the control unit 14 receives a message through the antenna 19, the radio unit 17, and the reception processing unit 16, and passes the message to the system-coordination control unit 13 (Step S1), the system-coordination control unit 13 then determines the radio network system to which its own node currently belongs (operates) (Step S2). When the system to which its own node belongs has not yet been decided (undecided at Step S2), the system-coordination control unit 13 regards the system corresponding to the received message as a system to which its own node belongs (Step S3), transfers the message to a communication processing unit corresponding to the received message (to the first communication processing unit 11 or to the second communication processing unit 12) (Step S9), and ends the processing.

When the system to which its own node belongs is the first system (the first system at Step S2), the system-coordination control unit 13 determines which system the received message has come from (Step S4). When the received message has come from the first system that is the same as the system to which its own node belongs (the first system at Step S4), the system-coordination control unit 13 transfers the received message directly to the first communication processing unit 11 (Step S9).

On the other hand, when the received message has come from the second system (the second system at Step S4), the system-coordination control unit 13 performs a notification process to adjacent nodes (in this case, a process for notifying the adjacent nodes of the fact that its own node temporarily becomes unavailable) (Step S5), transfers the received message to a communication processing unit corresponding to the received message (in this case, to the second communication processing unit 12) (Step S9), and ends the processing.

When it is determined at Step S2 that the system to which its own node belongs is the second system (the second system at Step S2), the system-coordination control unit 13 determines which system the received message has come from (Step S6). When the received message has come from the second system that is the same as the system to which its own node belongs (the second system at Step S6), the system-coordination control unit 13 confirms whether the received message is a communication end message (Step S7). When the received message is a communication end message (YES at Step S7), the system-coordination control unit 13 performs a notification process to adjacent nodes (in this case, a process for notifying the adjacent nodes of the fact that its own node becomes available) (Step S5) and advances the processing to Step S9.

When the received message is not a communication end message (NO at Step S7), the processing advances to Step S9. When the received message is a message from the first system at Step S6 (the first system at Step S6), the system-coordination control unit 13 disposes of the message (Step S8) and ends the processing.

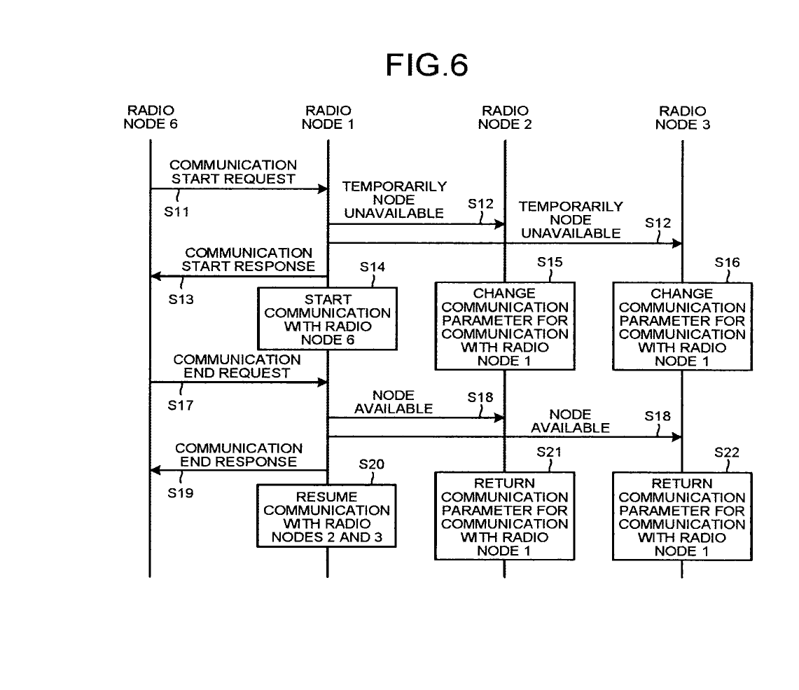

A notification process to adjacent nodes is explained next with reference to FIG. 6. FIG. 6 is a chart of an example of a notification process procedure to adjacent nodes. When the radio node 1 receives a communication-start request message from the radio node 6 (Step S11), the radio nodes 2 and 3 adjacent to the radio node 1 are notified of temporary node unavailability through the operation of the system-coordination control unit 13 described above (Step S12). Thereafter, in the radio node 1, a response message to the communication start request (a communication start response) is sent back by the second communication processing unit 12 (Step S13), and communication between the radio node 1 and the radio node 6 is started (Step S14).

The radio nodes 2 and 3 that have received a temporary node unavailability message from the radio node 1 change radio communication parameters for communication with the radio node 1 in the database 18 (Steps S15 and S16). Examples of the radio communication parameters include the number of retransmissions of a message (the upper limit value of the number of retransmissions of a message) and the timer value for waiting for a response. The radio communication parameters are changed to values such that the radio node 1 is riot detected as faulty even when the message transfer performance of the radio node 1 is degraded, for example, when the number of retransmissions of a message is increased or the timer value for waiting for a response is increased. In a case where the time during which the radio node 1 is temporarily not able to communicate has already been known for example, the radio communication parameters are changed to values such that the radio node 1 is not determined as faulty even when there is no response from the radio node 1 during this time. Therefore, the radio nodes 2 and 3 do not determine that the radio node 1 is a faulty node even when the radio node 1 does not temporarily respond to the radio nodes 2 and 3, and the radio nodes 2 and 3 do not perform an operation such as changing routing information in the first system.

When the radio node 1 receives a communication end message from the radio node 6 (Step S17), the radio node 1 notifies the radio nodes 2 and 3 of node availability (Step S19). The radio node 1 transmits a response to the communication end message (Step S19). Upon reception of the node availability, the radio nodes 2 and 3 return the radio communication parameters for communication with the radio node 1 to its original values (Steps S21 and S22). Accordingly, the first system including the radio node 1 is resumed, and the radio node 1 resumes radio communication with the radio nodes 2 and 3 (Step S20).

As described above, in the present embodiment, when the radio network system to which the radio node 1 belongs, is changed, the radio node 1 notifies its adjacent nodes of the change (node unavailability), and the adjacent nodes change the radio communication parameters for communication with the radio node 1. This prevents the radio node 1 from being treated as a faulty node in the first system, and can also prevent occurrence of unnecessary traffic in the network that provides the main service.

### Second Embodiment

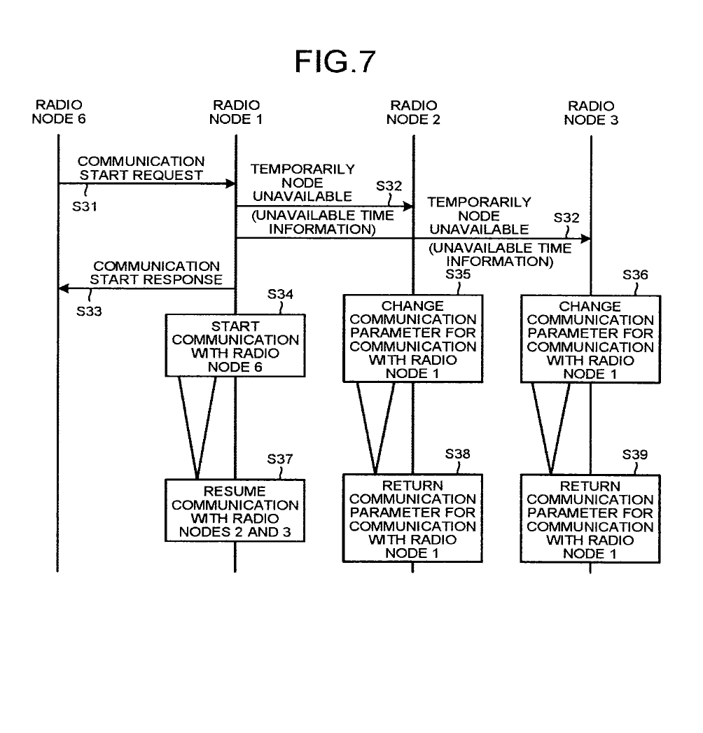

FIG. 7 is a chart of an example of an operation sequence of a radio network system according to a second embodiment of the present invention. The configuration of the radio network system according to the present embodiment and the configuration of each of radio nodes that constitute the radio network system are similar to those in the first embodiment.

In the first embodiment, when the radio node 1 returns to the first system, the radio node 1 notifies adjacent nodes of a return from the temporary unavailability and from the unavailability by transmitting a notification message. However, in the present embodiment, the radio node 1 notifies the adjacent nodes of the unavailable time to omit transmission of a message for notifying the adjacent nodes of a cancellation of the temporary node unavailability state.

As shown in FIG. 7, when the radio node 1 receives a communication-start request message from the radio node 6 (Step S31), the radio nodes 2 and 3 adjacent to the radio node 1 are notified of temporary node unavailability through an operation of the system-coordination control unit 13 (Step S32). At this point, information regarding the time during which the radio node 1 is unavailable (the unavailable time) is set in a temporary node unavailability notification message. Thereafter, in the radio node 1, a response to the communication start request is sent back by the second communication processing unit 12 (Step S33). Communication between the radio nodes 1 and 6 is started, and simultaneously the timer for measuring the unavailable time notified in the temporary node unavailability notification message is activated (Step S34).

The radio nodes 2 and 3 that have received a temporary node unavailability message from the radio node 1 change the radio communication parameters for communication with the radio node 1 in the database 18 (Steps S35 and S36). The radio communication parameters are changed similarly to the first embodiment. Simultaneously with changing the radio communication parameters, the timers for measuring the unavailable time that the radio nodes 2 and 3 are notified of are activated.

In the radio node 1, when the activated timer expires, communication with the radio nodes 2 and 3 is resumed (Step S37). In the radio nodes 2 and 3, when their respective activated timers expire, the radio communication parameters are returned to its original values (Steps S38 and S39), and the first system including the radio node 1 is resumed. Operations of the present embodiment except for those described above are similar to those of the first embodiment.

As described above, in the present embodiment, when the radio network system to which the radio node 1 belongs is changed, the radio node 1 notifies the radio nodes 2 and 3 of the unavailable time and therefore can achieve a return from unavailability (a return of the radio communication parameters) without using any message. Accordingly, the same service as that in the first embodiment can be controlled with less radio traffic in comparison with the first embodiment.

### Third Embodiment

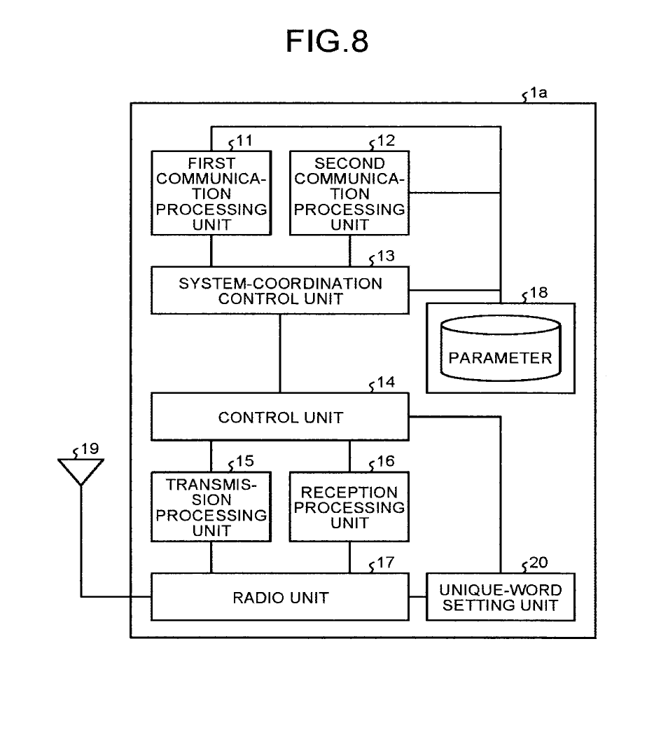

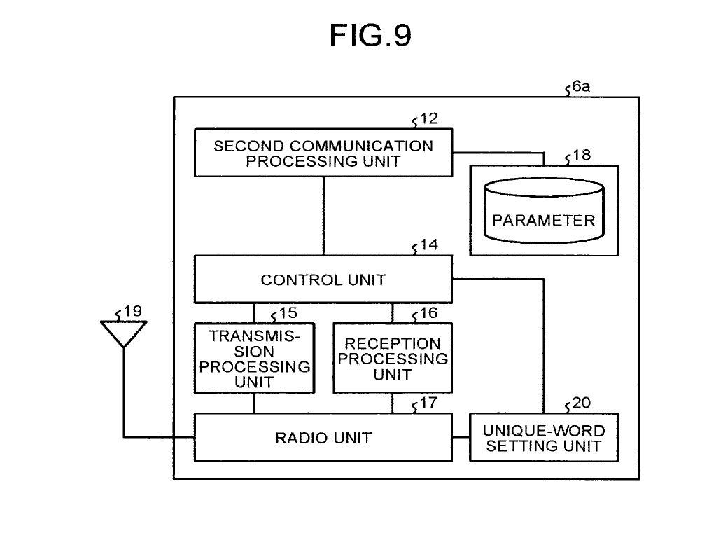

FIG. 8 is a diagram of a configuration example of a radio node 1a that constitutes a radio network system according to a third embodiment of the present invention. FIG. 9 is a diagram of a configuration example of a radio node 6a (a radio node that belongs to the second system) that constitutes the radio network system according to the third embodiment of the present invention. The configuration of the radio network system according to the present embodiment is similar to that of the first embodiment except that the radio nodes 1 and 6 in the first embodiment are replaced by the radio nodes 1a and 6a, respectively.

In the first and second embodiments, a notification that the radio network system to which the radio node 1 belongs has been changed is realized by a message. However, in the present embodiment, this notification is realized by radio-line-layer information, not by a message.

As shown in FIG. 8, the radio node 1a in present embodiment is similar to the radio node 1 in the first embodiment except that a unique-word setting unit 20 that sets a unique word pattern to be used in the radio unit 17 under the control of the control unit 14 is added to the radio node 1 in the first embodiment. Further, as shown in FIG. 9, the radio node 6a in the present embodiment is similar to the radio node 6 in the first embodiment except that the unique-word setting unit 20 that sets a unique word pattern to be used in the radio unit 17 under the control of the control unit 14 is added to the radio node 1 in the first embodiment. Constituent elements having functions similar to those in the first embodiment are denoted by like reference signs of the first embodiment and redundant explanations thereof will be omitted.

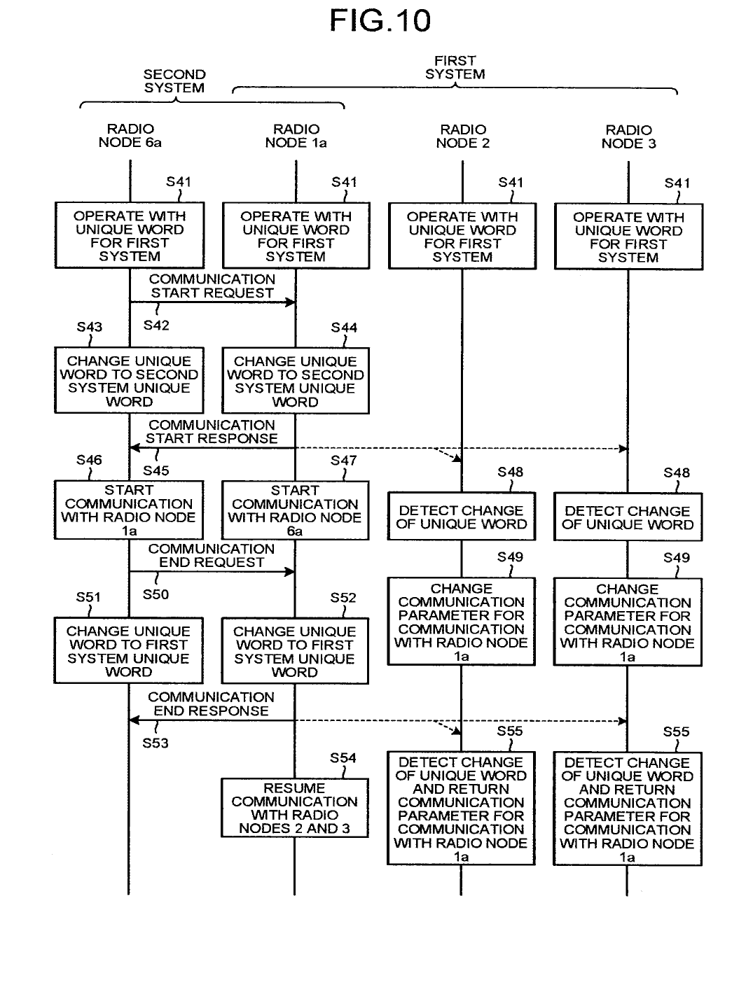

FIG. 10 is a sequence diagram of an operation example in the present embodiment. All the radio nodes use a unique word for the first system until communication in the second system is started (Step S41). When the radio node 1a receives a communication-start request message from the radio node 6a (Step S42), the system-coordination control unit 13 operates to determine that the radio network system to which the radio node 1a belongs is changed from the first system to the second system, and to instruct the unique-word setting unit 20 to change the unique word to be transmitted to a pattern for the second system. Based on the instruction, the unique-word setting unit 20 changes the unique word to the pattern for the second system (Step S44).

Also in the radio node 6a having transmitted a communication-start request message, the unique-word setting unit 20 changes the unique word to be transmitted to the pattern for the second system (Step S43). Thereafter, the radio node is and the radio node 6a use the unique word pattern for the second system to perform communication.

In the radio node 1a, the second communication processing unit 12 operates to respond to the communication start request (Step S45). Communication between the radio nodes 1a and 6a is started (Steps S46 and S47).

When the radio node 1a transmits a response to the communication start request to the radio node 6a, the radio nodes 2 and 3 detect the unique word transmitted from the radio node 1a (Step S48), and therefore determine that the radio node 1a temporarily becomes unavailable and then change respective radio communication parameters for communication with the radio node 1a (Step S49). The radio communication parameters are changed in a similar manner to the first and second embodiments.

When a communication end request is transmitted from the radio node 6a to the radio node is (Step S50), each of the radio node 1a and the radio node 6a returns the unique word to the pattern for the first system (Steps S51 and S52). The radio node 1a transmits a communication end response to the radio node 6a (Step S53).

When the radio node 1a transmits the communication end response to the radio node 6a, the radio nodes 2 and 3 detect the unique word transmitted from the radio node 1a, and return the radio communication parameters for communication with the radio node 1a to the parameters for the first system (Step S55). The radio node 6a resumes communication with the radio nodes 2 and 3 (Step S54). Therefore, the first system including the radio node 1a is resumed.

As described above, when the radio network system to which the radio node 1a belongs is changed, notification of the change to adjacent nodes is performed by changing the unique word pattern. Therefore, the same effects as those in the first embodiment can be obtained, and also radio wave transmission for the notification to the radio nodes 2 and 3 becomes unnecessary.

### Fourth Embodiment

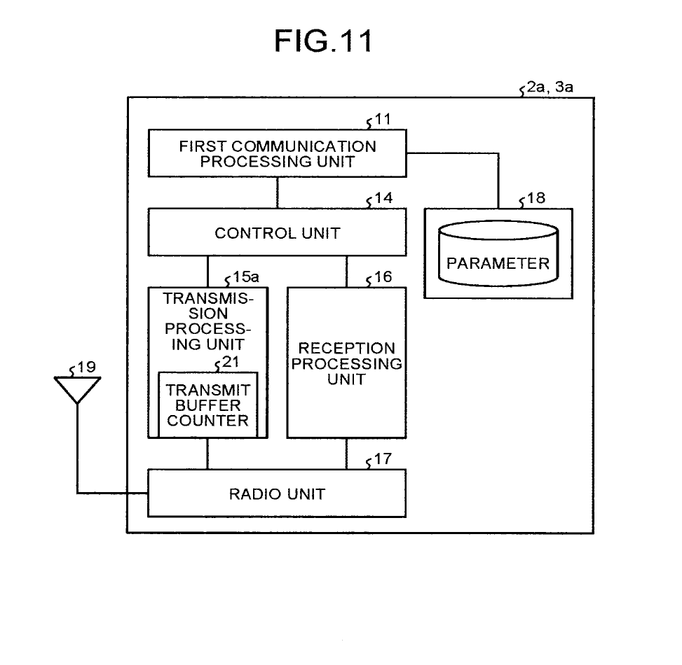

FIG. 11 is a diagram of a configuration example of radio nodes 2a and 3a (radio nodes that are adjacent to a shared node and belong to the first system) that constitute a radio network system according to a fourth embodiment of the present invention. The configurations of the radio nodes 2a and 3a are similar to those of the radio nodes 2 and 3 in the first embodiment except that the transmission processing unit 15 is replaced by a transmission processing unit 15a. The configuration of the radio network system according to the present embodiment is similar to that of the first embodiment except that the radio nodes 2 and 3 in the first embodiment are replaced by the radio nodes 2a and 3a, respectively.

In the present embodiment, an explanation is made of an example of an operation of the radio nodes 2a and 3a when being notified of a movement of the radio node 1 to a different radio network system (notified of temporary node unavailability) from the radio node 1.

An explanation is made of an example of the radio nodes 2 and 3 that determine whether to change the parameter values so as not to regard the radio node 1 as faulty or whether to determine the radio node 1 as faulty and therefore construct a new routing path.

In the present embodiment, the transmission processing unit 15a in each of the radio nodes 2a and 3a includes a transmit buffer counter 21 that counts the number of pieces of transmission data accumulated in a transmit buffer (not shown). Based on the information in the transmit buffer counter 21, the radio nodes 2a and 3a in the present embodiment decide whether to set a bypass route by regarding the radio node 1 as faulty or whether to change the communication parameters for communication with the radio node 1 without regarding the radio node 1 as faulty.

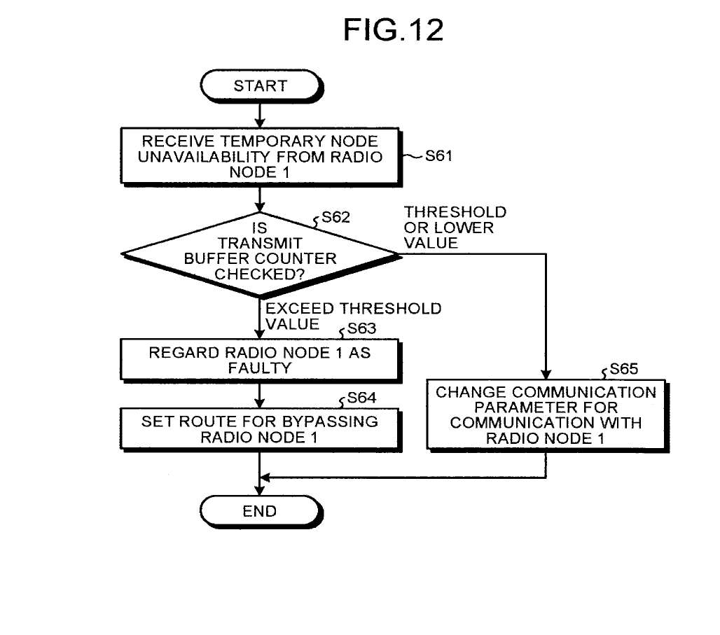

FIG. 12 is a flowchart of an operation example when the radio nodes 2a and 3a in the present embodiment receive temporary node unavailability. Upon reception of the temporary node unavailability from the radio node 1 (Step S61), the radio nodes 2a and 3a confirm whether the accumulated transmission data exceeds a buffer threshold value based on the information in the transmit buffer counter 21 (that is, the count value of the number of pieces of transmission data accumulated in the transmit buffer) (Step S62). When the accumulated transmission data exceeds the buffer threshold value (exceed the threshold value at Step S62), the radio nodes 2a and 3a regard the radio node 1 as a faulty node (Step S63) and perform route setting to bypass the radio node 1 (Step S64).

When the accumulated transmission data does not exceed the buffer threshold value (the threshold value or lower at Step S62), the radio nodes 2a and 3a set the communication parameters for communication with the radio node 1 to values such that the radio node 1 is not recognized as faulty (Step S65). Operations of the present embodiment except for those described above are similar to those of the first embodiment.

In the above explanations, the notification method of notification of the temporary node unavailability and cancellation of the temporary node unavailability is similar to that in the first embodiment. However, the notification of the temporary node unavailability and the cancellation of the temporary node unavailability can be performed similarly to those in the second and third embodiments.

As described above, in the present embodiment, in a case where the radio nodes 2a and 3a adjacent to the radio node 1 receive the temporary node unavailability, when the number of pieces of transmission data accumulated in the transmit buffer exceeds the buffer threshold value, the radio node 1 is treated as a faulty node. Therefore, in a case where the radio node 1 moves to a different radio network system, when a large number of transmission messages are accumulated in the adjacent nodes, the bypass route can be set to avoid traffic stagnation on the side of the radio network system that provides the main service.

### Fifth Embodiment

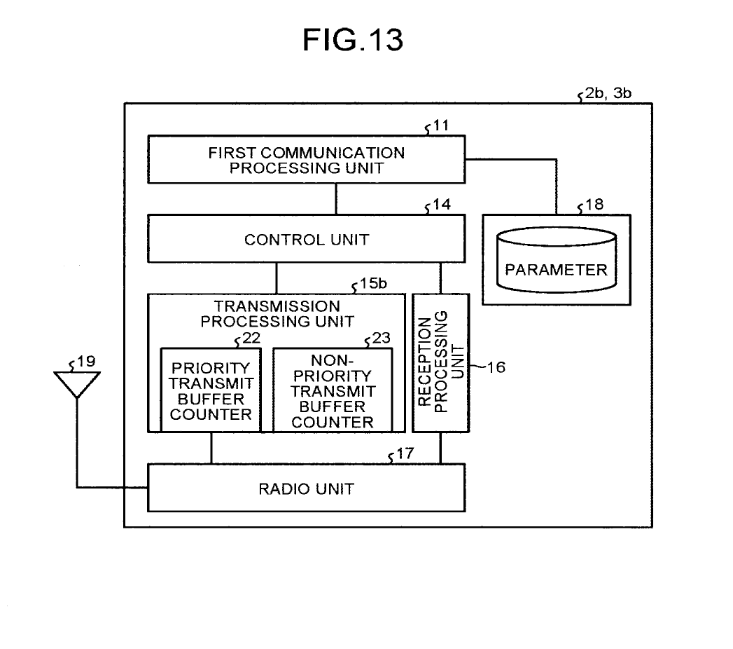

FIG. 13 is a diagram of a configuration example of radio nodes 2b and 3b that constitute a radio network system according to the fourth embodiment of the present invention. The configurations of the radio nodes 2b and 3b are similar to those of the radio nodes 2 and 3 in the first embodiment except that the transmission processing unit 15 is replaced by a transmission processing unit 15b. The configuration of the radio network system according to the present embodiment is similar to that of the first embodiment except that the radio nodes 2 and 3 in the first embodiment are replaced by the radio nodes 2b and 3b, respectively.

In the fourth embodiment, whether it is necessary to set a bypass route is decided based on the state of a single transmit buffer. However, in the present embodiment, an explanation is made of an example in which transmit buffers distinguished between a priority buffer and a non-priority buffer are included. Each of the radio nodes 2b and 3b according to the present embodiment includes a priority transmit buffer and a non-priority transmit buffer (both not shown) that accumulate therein data according to the priority of transmission data.

The transmission processing unit 15b in each of the radio nodes 2b and 3b in the present embodiment includes a priority transmit buffer counter 22 that counts the number of pieces of transmission data accumulated in the priority transmit buffer, and a non-priority transmit buffer counter 23 that counts the number of pieces of transmission data accumulated in the non-priority transmit buffer.

An operation of the radio nodes 2b and 3b in the present embodiment upon reception of the temporary node unavailability is similar to that in the fourth embodiment except that information in the priority transmit buffer counter 22 (that is, the number of pieces of transmission data accumulated in the priority transmit buffer) is used, instead of the information in the transmit buffer counter 21, for comparison with the buffer threshold value at Step S62 explained in the fourth embodiment. Operations of the present embodiment except for those described above are similar to those of the first embodiment.

As described above, in the present embodiment, in a case where the radio nodes 2b and 3b adjacent to the radio node 1 receive the temporary node unavailability, when the number of pieces of transmission data accumulated in the priority transmit buffer exceeds the buffer threshold value, the radio node 1 is treated as a faulty node. Therefore, in a case where the radio node 1 moves to a different radio network system, when a large number of high-priority transmission messages are accumulated in the adjacent nodes, the bypass route can be set to avoid traffic stagnation on the side of the radio network system that provides the main service.

### INDUSTRIAL APPLICABILITY

As described above, the radio communication system, the radio communication apparatus, and the radio communication method according to the present invention are useful for a radio communication system that shares a radio communication apparatus among a plurality of radio networks.

### REFERENCE SIGNS LIST

1, 1a, 2, 2a, 2b, 3, 3a, 3b, 4, 5, 6, 6a radio node, 7 first radio network system, 8 second radio network system, 11 first communication processing unit, 12 second communication processing unit, 13 system-coordination control unit, 14 control unit, 15, 15a, 15b transmission processing unit, 16 reception processing unit, 17 radio unit, 18 database, 19 antenna, 20 unique-word setting unit, 21 transmit buffer counter, 22 priority transmit buffer counter, 23 non-priority transmit buffer counter.

1. A radio communication system that allows coexistence of a plurality of radio network systems, the system comprising:
a shared node that belongs to a first radio network system that is one of the radio network systems and that belongs to a second radio network system that is one of the radio network systems and is different from the first radio network system; and
an adjacent node that belongs to the first radio network system and is adjacent to the shared node, wherein
the shared node includes a system-coordination control unit that, when the shared node starts operating as a radio node that belongs to the second radio network system, gives a notification of temporary node unavailability indicating that the shared node temporarily becomes unavailable, and
the adjacent node includes a communication processing unit that, upon reception of a notification of the temporary node unavailability, changes a radio communication parameter between the adjacent node and the shared node to a value such that the shared node is not detected as faulty even when there is no response from the shared node for a certain period of time.

2. The radio communication system according to claim 1, wherein a notification of the temporary node unavailability is given by a message.

3. The radio communication system according to claim 1, wherein a notification of the temporary node unavailability is given by changing a unique word used within the second radio network system.

4. The radio communication system according to claim 1, wherein
when the shared node ends operating as a radio node that belongs to the second radio network system, the system-coordination control unit gives a notification of node availability indicating that the shared node becomes available, and
upon reception of a notification of the node availability, the communication processing unit returns the radio communication parameter between the adjacent node and the shared node to a value before a change based on a notification of the temporary node unavailability is made.

5. The radio communication system according to claim 4, wherein a notification of the node availability is given by a message.

6. The radio communication system according to claim 4, wherein when a notification of the temporary node unavailability has been given by changing a unique word used within the second radio network system, a notification of the node availability is given by returning the unique word used within the second radio network system to a value before a change based on the temporary node unavailability.

7. The radio communication system according to claim 1, wherein
upon giving a notification of the temporary node unavailability, the system-coordination control unit gives a notification of an unavailable time that is a time during which the shared node is unavailable, and
when the unavailable time has elapsed from a time point when a notification of the temporary node unavailability is received, the communication processing unit returns the radio communication parameter between the adjacent node and the shared node to a value before a change based on a notification of the temporary node unavailability is made.

8. The radio communication system according to claim 1, wherein when a preset condition is satisfied upon reception of a notification of the temporary node unavailability, the adjacent node regards the shared node as a faulty node and performs path changing processing without changing the radio communication parameter between the adjacent node and the shared node.

9. The radio communication system according to claim 8, wherein
the adjacent node sets the condition to be that transmission data stored in a transmit buffer exceeds a predetermined buffer threshold value, and
when transmission data stored in the transmit buffer exceeds the predetermined buffer threshold value, the adjacent node performs the path changing processing.

10. The radio communication system according to claim 8, wherein
the adjacent node
stores higher-priority transmission data among the transmission data in a priority transmit buffer,
sets the condition to be that the transmission data stored in the priority transmit buffer exceeds a predetermined buffer threshold value, and
performs the path changing processing when the transmission data stored in the priority transmit buffer exceeds the predetermined buffer threshold value.

11. The radio communication system according to claim 1, wherein
the radio communication parameter is number of retransmissions of a message, and
upon reception of a notification of temporary node unavailability, the communication processing unit increases an upper limit value of the number of retransmissions of a massage to the shared node.

12. The radio communication system according to claim 1, wherein
the radio communication parameter is a timer value for waiting for a response, and
upon reception of a notification of temporary node unavailability, the communication processing unit increases the timer value for waiting for a response from the shared node.

13. A radio communication apparatus that belongs to a radio communication system that allows coexistence of a plurality of radio network systems, wherein
the radio communication apparatus belongs to a first radio network system that is one of the radio network systems and belongs to a second radio network system that is one of the radio network systems and is different from the first radio network system, and
the radio communication apparatus comprises a system-coordination control unit that, when the radio communication apparatus starts operating as a radio node that belongs to the second radio network system, notifies an adjacent node that is adjacent to the radio node and belongs to the first radio network system of temporary node unavailability indicating that the radio node temporarily becomes unavailable.

14. A radio communication apparatus in a radio communication system that allows coexistence of a plurality of radio network systems, the radio communication apparatus belonging to a first radio network system that is one of the radio network systems, wherein
the radio communication system includes a shared node that belongs to the first radio network system and belongs to a second radio network system that is one of the radio network systems and is different from the first radio network system, and
the radio communication apparatus comprises a communication processing unit that, upon reception of temporary node unavailability indicating that the shared node temporarily becomes unavailable from the shared node adjacent to the radio communication apparatus, changes a radio communication parameter between the radio communication apparatus and the shared node to a value such that the shared node is not detected as faulty even when there is no response from the shared node for a certain period of time.

15. (canceled)
